(19) United States
(12) Patent Application Publication
(10) Pub. No.: US 2010/0034900 A1
(43) Pub. Date: Feb. 11, 2010

(54) METHOD OF MANUFACTURING ANTIMICROBIAL COATING

(76) Inventors: Marina Temchenko, Swampscott, MA (US); Samuel Lim, Lynn, MA (US); Michael W. Sullivan, Upton, MA (US); David William Avison, Townsend, MA (US)

Correspondence Address: NORRIS MCLAUGHLIN & MARCUS, P.A., 721 ROUTE 202-206, P.O.BOX 5933, BRIDGEWATER, NJ, 08807-5933, US

(21) Appl. No.: 12/509,563

(22) Filed: Jul. 27, 2009

Related U.S. Application Data
(60) Provisional application No. 61/086,889, filed on Aug. 7, 2008.

(51) Int. Cl. A01N 59/16; A01P 1/00

(52) U.S. Cl. 424/618

(57) ABSTRACT

A method of coating a substrate with the biocide particles dispersed into a coating permitting the antimicrobial particles to be positioned on the substrate such that they are in contact with the environment is provided. In the method, one or more biocides agents are dispersed into a coating. The coating with the biocide agent is applied to a substrate at a thickness such that at least some of the individual biocide particles extend beyond the surface of the coating.

### CROSS REFERENCE TO RELATED APPLICATION

This application claims the benefit of U.S. Provisional Patent Application No. 61/086,889, filed Aug. 7, 2008, the entirety of which is hereby incorporated by reference into this application.

### BACKGROUND OF THE INVENTION

1. Field of the Invention

The present invention relates to antimicrobial coatings. More particularly, the present invention relates to the application of antimicrobial coatings to substrates.

2. Description of Related Art

Silver and silver salts are known antimicrobial agents, alternatively referred to as biocide agents. Other metals, such as gold, zinc, copper and cerium, have also been found to possess antimicrobial properties, both alone and in combination with silver. These and other metals have been shown to provide antimicrobial behavior even in minute quantities, a property referred to as “oligodynamic.” Many techniques are used to incorporate metallic biocide agents into a material or substrate to inhibit microbial growth.

One conventional approach for obtaining antimicrobial surfaces is the deposition of metallic silver (or other oligodynamic metal) directly onto the surface of the substrate, for example, by vapor coating, sputter coating, or ion beam coating. These so called non-contact deposition coating techniques, however, have many disadvantages, such as poor adhesion, lack of coating uniformity, and the need for special processing conditions, such as preparation in darkness due to the light sensitivity of some silver salts. These methods are not satisfactory and do not provide effective, consistent antimicrobial effect over time.

Another method of coating silver onto a substrate involves deposition or electrodeposition of silver from solution. These methods also have disadvantages including poor adhesion, low silver pick-up on the substrate, the need for surface preparation, and high labor costs associated with multi-step dipping operations usually required to produce the coatings. Adhesion problems have been addressed by inclusion of deposition agents and stabilizing agents, such as gold and platinum metals, or by forming chemical complexes between a silver compound and the substrate surface. However, inclusion of additional components increases the complexity and cost of producing such coatings.

Another conventional approach of obtaining antimicrobial surfaces is the incorporation of silver, silver salts, and other antimicrobial compounds into the polymeric substrate material. An oligodynamic metal may be physically incorporated into the polymeric substrate in a variety of ways. For example, a liquid solution of a silver salt may be dipped, sprayed or brushed onto the solid polymer, for example, in pellet form, prior to formation of the polymeric article. Alternatively, a solid form of the silver salt can be mixed with a finely divided or liquefied polymeric resin, which is then molded into an article or substrate. Alternatively, the oligodynamic compound can be mixed with monomers of the material prior to polymerization.

These approaches require large quantities of the oligodynamic material and provide limited antimicrobial effect at the surface of the substrate or film because oligodynamic metal is primarily entirely within the polymer and not on the surface where it is needed. Such a method provides only limited antimicrobial activity in relation to amount of antimicrobial agent used. Settling of particles of the oligodynamic agent occurs as a result of the size and density of the particles. Settling leads to unpredictable changes in the concentration of the oligodynamic agent in the composition resulting in areas with little or no antimicrobial activity, especially on the surface of the substrate or film.

Conventional methods of incorporating a biocide agent involve dispersing the particles into the base polymeric film. These base polymeric films are typically several hundred times thicker than the average biocide particle size. This resulting film is not effective as an antimicrobial surface as the vast majority of biocide particles is encapsulated entirely or nearly entirely into the base substrate and has no useful effect. In these prior art methods, the biocide particles are dispersed into the polymeric film when extruded, and therefore cannot move to the surface to exchange their ions with ambient moisture. In effect, these particles, by being encased into the film are wasted.

It would be desirable to have an antimicrobial coating or film where the biocide agent is positioned and in contact with the surface to which it is applied. It would be desirable to have a method and film that provides antimicrobial inhibition and prevention at the surface of a substrate.

### SUMMARY OF THE INVENTION

A method of producing a substrate with an antimicrobial coating is provided. The antimicrobial coating contains biocide particles (alternatively referred to biocide agent or antimicrobial agent) dispersed into a coating. The coating with the biocide agent is applied to a substrate at a thickness such that at least some of the individual biocide particles extend beyond the surface of the coating and in contact with the environment.

An antimicrobial film, laminate or substrate is also provided. The film, laminate or substrate has a base polymer film, a coating on at least one of the surfaces of the base polymer film, and one or more biocide agents dispersed in the coating, wherein at least some of the individual biocide particles extend beyond the surface of the coating when the coating is cured.

A method of inhibiting microbial growth on a solid surface is also provided. The method includes the step of applying an antimicrobial film to the solid surface. The antimicrobial film comprises a base polymer film, a coating on at least one of the surfaces of the base polymer film, and one or more biocide agents dispersed in the coating. At least some of the individual biocide particles extend beyond the surface of the coating when the coating is cured. This is accomplished by controlling the thickness of the coating in relation to the size of the particle size of the biocide in the coating.

By controlling the thickness of the coating, the amount of biocide agent that is exposed above the surface can be controlled. Prior methods unsuccessfully relied on irregular shapes and orientation to attempt having the biocide protrude above the surface. In contrast, the inventive method provides for much more precise control over the positioning of the biocide agent at the surface of the coating.

The antimicrobial efficacy of the surface of a coating is proportional to the amount of biocide agent concentration at the surface (as opposed to buried under the surface). The method of this invention allows for the surface concentration of biocide agent to be precisely controlled by adding or removing agent to the dispersion. In prior methods, this concentration would be evenly distributed throughout the base polymer film with only a small fraction, if any, of the biocide agent penetrating the surface where it is most effective. The inventive method allows for better efficacy control and cost reduction. First, the average particle size distribution can be calculated; and based on this distribution, a coating thickness can be determined based on the desired surface area to be exposed.

In addition to providing improved efficacy for controlling microbial growth, surfaces prepared in accordance with the invention provide a stronger, more durable coating or film. The coating or film has increased hardness that is resistant to scratches and abrasions. While the biocide agent actually extends beyond the surface of the film, the types of biocide agents used in some embodiments produce non-toxic and non-irritating surfaces.

### BRIEF DESCRIPTION OF THE DRAWINGS

The following drawings are for illustrative purposes only and are not intended to limit the scope of the present invention in any way:

FIG. 1 illustrates a side view of one embodiment of substrate coated with an antimicrobial coating.

FIG. 2 illustrates an enlarged view of individual biocide particles within the coating.

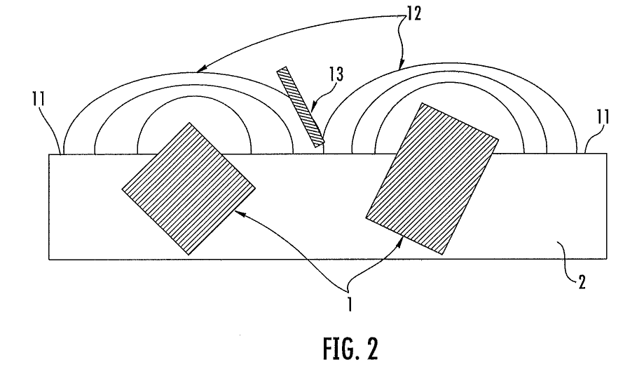

### DETAILED DESCRIPTION

### Overview

A method of providing an antimicrobial surface to a substrate is provided. In the method, an antimicrobial coating is applied to the surface of a substrate to provide antimicrobial protection to the substrate. The coating is prepared by making a dispersion of a biocide agent in a curable or other type of coating into which the biocide agent can be dispersed. The dispersion is coated onto the surface of the substrate at a thickness that is less than the average particle size of the biocide agent. Because of the physical dimensions of the particles and the thickness of the coating, at least some of the biocide particles extending beyond the surface of the coating as shown in the Figures.

In this way, at least some of the biocide particles are in direct contact with the environment at the surface where the coating is applied. The proximity of the biocide particles to the air (and hence the microbes) provides superior antimicrobial prevention of microbial growth to the substrate as compared to conventional methods where the biocide agent is completed encapsulated in the substrate.

The coating is applied to virtually any solid substrate to prevent or inhibit microbial growth and/or increase the hardness and durability of the substrate. The coating can be applied directly to virtually any type of firm or rigid substrate. Alternatively, the antimicrobial coating can be indirectly applied to a film or laminate, which film or laminate is subsequently applied to a substrate. In this alternate method, a film or laminate is coated with the dispersion in the same manner that it is applied directly to a substrate. The resulting antimicrobial film or laminate has antimicrobial properties and/or scratch resistant properties and can be applied or adhered to any number of substrates. This film or laminate can be replaced as needed based on the degree of wear and traffic.

The coating can be any type of material into which biocide particles can be dispersed. The coating is applied to a substrate as a liquid or fluid dispersion and then cured, dried, crosslinked, set or otherwise hardened onto the substrate such that the biocide particles, or at least some of the particles, extend beyond the surface of the hardened coating.

### DESCRIPTION OF PREFERRED EMBODIMENT

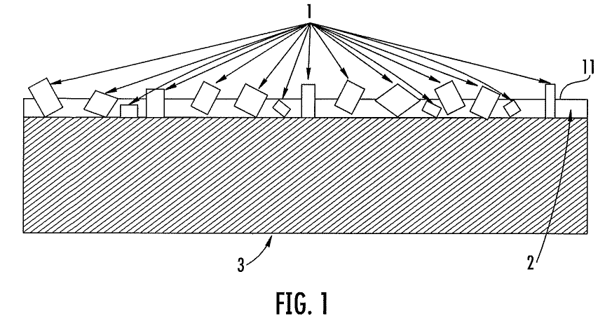

Referring to FIG. 1, a substrate 3 provides the base for an antimicrobial coating 2. The coating 2 contains biocide particles 1 embedded or affixed within the coating 2. The coating 2 provides antimicrobial protection to the surface 4 of the substrate 3. As illustrated in FIG. 1, many of the particles 1 are larger than the thickness of the coating 2. The particles 1 extend beyond the surface of the coating 2 regardless of the orientation of the particles 2. Some particles 1 may be smaller than the thickness of coating 2, and as a result completely embedded in the coating. This will not negatively affect the antimicrobial properties of the coating 2 so long a significant proportion of the particles 1 extend beyond the surface.

The specific type of coating 2, substrate 3, and biocide particles 1 varies and can be one or a combination of many commonly used in the art. The specific choice of coating 2 will depend on the specific application (intended us of the final product to which the coating is being applied) and/or the type of substrate 2 being used (discussed in more detail below). In some embodiments the coating 2 is a curable coating, preferably capable of being cross-linked. When a crosslinkable coating 2 is used, method of initiating curing or cross-linking is not critical and can be any number of methods typically used in the art. In one preferred embodiment the coating is cross-linked via Ultra Violet light with an appropriate photo initiator. In another method the coating is thermally cured once the coating is applied to the substrate.

When a curable coating is used, the biocide agent is evenly dispersed in the uncured coating and then applied to the substrate. The coating will typically not be cured until it is applied to the substrate but in some embodiments the coating can be partially or fully cured prior to being applied to the substrate. In other embodiments, the coating is not a curable type of coating.

Generally, the coating can be any type of material that can be applied to a substrate and into which the biocide particles can be dispersed. Once applied to the substrate the coating hardens, dries, or otherwise sets so that the biocide particles extend beyond the surface of the coating. Other types of coating 2 can be used including, for example, a solvent or water based coating. In a solvent or water based coating, the biocide agent is dispersed in the coating and then the solvent or water is driven off after the coating 3 is applied to the substrate 3. Other non-limiting examples of useful coatings include 100% solids, extruded coatings, cast films, hot melt extrusion, to name a few. The coating need not be polymeric so long as the coating can be applied to a substrate and incorporate the biocide agent and be applied to the substrate as described in more detail below.

Whether curable on non-curable, the biocide (antimicrobial) coating is produced by dispersing the biocide agent into the coating. Preferably the biocide agent is dispersed in uniform manner throughout the coating. In this way the coating will provide more consistent microbial protection to the areas on which it is applied. The concentration of biocide agent is preferably in the range from about 1% to about 5% loading as a percent of solids. More or greater percentage can be used depending on the type of biocide and the acceptable haze value of the coating. In one especially preferred embodiment, the concentration of biocide in dry coating is about 3% by weight. This percentage provides excellent antibacterial efficacy while still producing a low haze value.

The biocide can be dispersed into the coating by any means commonly used in the art. For one example, the biocide agent is dispersed into the monomer matrix (or other coating matrix) with a high speed disperser at about 2000 rpms. This provides a dispersion speed of about 4180 FPM at the blade (8 inch) tip. It is dispersed for about 15 minutes (or until evenly distributed in the matrix. Preferably, the mixture is continuously agitated at the machine until just prior to coating to maintain homogeneity.

The substrate 3 can be virtually any material or surface for which antimicrobial protection or growth inhibition is desired. The coating can be applied directly to virtually any type of firm or rigid or semi-rigid substrate that will support a coating. In some embodiments the substrate 3 is a polymer film, such as PET. The substrate 3 need not be polymeric however and can be any material on which a coating 2 can be applied, including for example, paper, drywall, plaster, foil, metal, concrete, stainless steel, and wood.

In order to provide effective antimicrobial effect, a portion of at least some of the biocide particles 1 extend beyond the surface of the coating 2 such that some surface of the particles are in contact with the environment. Referring to drawing 2, a close up of the individual biocide particles 1 extending beyond the surface coating 11 is shown. Because the particles 1 extend beyond the surface 11, the particles 1 can interact with ambient moisture 12 present in the atmosphere. When bacteria, mold, or fungi 13 comes into contact with this surface film of moisture, the silver ions that have been exchanged with sodium ions began to interact with the cell functions and cell reproduction and growth is inhibited.

The biocide agent used in the preferred embodiment of this invention is ionic silver incorporated in zeolite or diatomaceous earth. Silver ions are able to be exchanged with positive ions (usually sodium ions) naturally present in the atmosphere. Release silver ions “on demand” provide antimicrobial properties to surfaces. Ionic silver incorporated in zeolite is commercially available through, for example, Aglon Technologies. Silver ions have been proven to inhibit the growth of bacteria, viruses, mold and fungi by inhibiting transport functions in the cell wall, inhibiting cell division, and disrupting cell metabolism.

In some embodiment, the average particle size is preferably about 4-5 μm mean. At this particle size, a range of about 2.3 to about 3.0 micron coating thickness is preferred. This insures a high percentage of the loading is exposed to the bacterial environment at the surface. That is, this ratio of coating thickness to mean particle size ensures that a high percentage of particles will extend beyond the surface of the coating and in direct contact with the environment. Different particle sizes can be used, however, in order to ensure that a significant number of particles extend beyond the surface; the mean particle size should be greater than the thickness of the coating.

Other biocide agents can be used. These alternative biocide agents can be used alone, or in combination. They can also be used in combination with ionic silver, or other biocide agents such as copper and cerium to name a few.

In addition to the antimicrobial properties of silver, the incorporation of the biocide agent, biocide particles, or zeolite or diatomaceous earth into the coating also functions to strengthen the film and provide hardness to the coating. The coating (once cured if a curable coating) is more scratch resistant as compared to the coating without the inclusion of biocide material. Zeolites are microporous aluminosilicates that occur naturally or are synthetically produced. The incorporation of zeolite containing biocide material provides more scratch resistance than silver without zeolite. In addition, in some embodiments, other additives are included to enhance scratch resistance. For example, polydimethylsiloxane or nano silica can be dispersed with the biocide agent. In one embodiment, 50 nm particle size of nano silica are added to the dispersion to enhance scratch resistance.

In most applications, the individual biocide particles or material (used interchangeably) used are provided in a range of sizes. Once applied to a substrate 3, some individual particles will be embedded into the coating and extend beyond the surface of the coating 2 at various depths. A coating thickness is then chosen based on the average thickness of the biocide particles. By choosing a dry weight, thickness less than the average particle size of the biocide agent, the biocide particles or material will extend above the coating. Since the particles then extend beyond the surface of the coating, they can come in direct contact with the environment surrounding them. Because some variation in the size of the individual biocide particles is to be expected, some particles may be completely encapsulated in the coating and not extend beyond the surface. This will not negatively impact the effectiveness so long as at least some of the biocide particles are in contact with the environment in a substantially consistent manner. Alternate methods may be used to incorporate the biocide particles at the surface of a coating. For example, water-swellable coatings may be used.

In most applications, the thickness of the coating 2 ranges from about 6 microns to about 250 microns. Preferably, the thickness is in the range from about 25 microns to 175 microns. This exact thickness will depend on the chemistry of the coating, the particle size of the biocide and on the nature of the substrate.

In an alternate embodiment, the substrate is a film or laminate and the anti-microbial coating is applied directly to a film or the top layer of the laminate. The antimicrobial top coating is applied to the film or laminate in the manner described above. The resulting film or laminate, sometimes referred to as antimicrobial overlay (“AMO”) can be used in a variety of applications, such as application on a solid surface. The base film, bottom coating or layer and top coating (anti-microbial layer) can each be chosen based on the specific application. In one application, the antimicrobial film or laminate is applied or adhered to the surface of a device or article, such as sinks, countertops, walls, and tables, to prevent the surface growth of microbes on the device or article on which it is applied. These durable AMO films help make health care centers, hospitals and food processing facilities' surfaces cleaner by resisting the growth of bacteria, mold and fungus. For example, in one embodiment ionic silver is coated onto a clear PET layer with a pressure sensitive adhesive on the bottom side. The resulting film is useful for a variety of applications including countertops, stainless steel, and overtop of existing touchscreens.

In one example of an AMO, a crosslinkable or curable polymeric coating is coated onto a polymeric film layer, either a single layer of film or a laminate, to form the AMO. In one embodiment, the bottom surface of the AMO is an adhesive layer or has adhesive applied to the bottom surface, for application of the AMO directly onto a surface. The adhesive can be one of typically used in the art, such as a solvent based acrylic adhesive. The resulting laminate or film can be applied wet or dry-laminated. Preferably, the adhesive is water clear and removable with no adhesive residue while also being tamper resistant. Tamper resistant in this instance means that the pressure sensitive adhesive is designed so that it sticks to a wide variety of surfaces, such as wood laminate, glass and stainless steel to name a few. The bond is sufficient that it cannot be easily removed after application, with some effort, hence tamper resistant, but once it is removed, it releases cleanly, no adhesive remains on the surface it was applied to.

The resulting antimicrobial film or laminate can be adhered to virtually any surface, such as for example, countertops, sinks, walls, tables, etc. to prevent the surface growth of bacteria and other microbes. The AMO can also be used to increase the strength of the surface to which it is applied and/or provide resistance against scratches and abrasions. This film can be replaced as needed based on the degree of wear and traffic. The AMO has excellent chemical resistance to such substances as water, mild acids, salts and alkalis, petroleum based grease, oils and aliphatic solvents.

In one embodiment, the coating 2 is a multi-functional aliphatic urethane acrylate (with a biocide agent dispersed as discussed above). The number of functional groups can range from a minimum of 2 to typically 6. Higher functionality increases the degree of crosslinking resulting in greater hardness and shrinkage. Other types of cross linking chemistries can be chosen based on end use of the product and environmental application requirements.

The polymeric layer of the AMO can be any type of film or laminate. In one embodiment, the film is PET. PET is useful in a number of applications because its high clarity makes it transparent. The thickness of the substrate in this embodiment is preferably between 2-mils and 7-mils. For thickness larger than about 7-mils, the PET substrate can be laminated to other substrates, such as one or more layers of polymeric film. Films with thickness below 2-mils can be coated, but are more difficult due to shrinkage from cross linking and heat from the UV-source. Optionally, a release liner, such as a 1 mil clear silicone coated polyester liner, is included.

In another example of an AMO, a film, such as a clear 7-mil PET film, is coating with the antimicrobial coating as described above. The bottom surface of the AMO is pre-treated to promote or facilitate ink adhesion. This embodiment is especially useful to be integrated into membrane switches. Preferably, the film is about 7-mil PET film and the amitmicrobial agent is silver zeolite, but other types of film, antimicrobial agents and coatings used in the art may be substituted. The bottom of the film is optionally includes a print treatable polyester layer. This AMO is suitable for a number of uses including integration into membrane switches.

Another example of an AMO prepared in accordance with the invention is designed to be integrated into touchscreens. In this example the base film of the AMO is 7-mil heat stabilized PET film. However, both the type of polymer and the thickness can be adjusted as needed according to the specific application. For example, the base film could be polycarbonate or another rigid polymeric film. Heat stabilization is generally preferred when the AMO is for touch screens. An antimicrobial coating as described above is applied to the top surface of the film. A masked, 250-ohm Indium Tin Oxide coating is applied to the bottom surface of the PET film.

### ALTERNATIVES

There will be various modifications, adjustments, and applications of the disclosed invention that will be apparent to those of skill in the art, and the present application is intended to cover such embodiments. Accordingly, while the present invention has been described in the context of certain preferred embodiments, it is intended that the full scope of these be measured by reference to the scope of the following claims.

What is claimed is:

1. A method for providing an antimicrobial surface on a substrate comprising the steps of:
dispersing one or more biocides agents into a coating;
applying the coating with the biocide agent to a substrate, wherein the coating is applied such that at least some of the individual biocide agent particles extend beyond the surface of the coating when applied.

2. The method of claim 1 wherein the substrate is a polymeric film.

3. The method of claim 1 wherein the coating is a curable coating.

4. The method of claim 1 wherein the coating is a crosslinkable coating.

5. The method of claim 1 wherein the one or more biocide agents includes ionic silver incorporated in zeolite.

6. The method of claim 1 wherein the thickness of the coating is less than the mean particle size of the biocide particles.

7. An antimicrobial film comprising:
a base polymer film;
a coating on at least one of the surfaces of the base polymer film, and
one or more biocide agents dispersed in the coating, wherein at least some of the individual biocide agent particles extend beyond the surface of the coating when the coating is applied to the film.

8. The antimicrobial film of claim 7, wherein the base polymeric film is PET.

9. The antimicrobial film of claim 7, wherein the coating is a crosslinkable coating.

10. The antimicrobial film of claim 7 wherein the one or more biocide agents includes ionic silver incorporated in zeolite.

11. The antimicrobial film of claim 7 wherein the base polymer film is a laminate.

12. The antimicrobial film of claim 11 wherein the laminate comprises a bottom adhesive layer.

13. The antimicrobial film of claim 11 wherein the laminate comprises a bottom layer of print treatable polyester.

14. The method of claim 7 wherein the thickness of the coating is less than the mean particle size of the one or more biocide agents.

15. A method of inhibiting microbial growth on a solid surface comprising:
applying an antimicrobial film to the solid surface wherein the antimicrobial film comprises
a base polymer film;
a coating on at least one of the surfaces of the base polymer film, and
one or more biocide agents dispersed in the coating, wherein at least some of the individual biocide particles extend beyond the surface of the coating when the coating is cured.

16. The method of claim 15 wherein the one or more biocide agents includes ionic silver incorporated in zeolite.

17. The method of claim 15 wherein the base polymer film is a laminate.

18. The method of claim 15 wherein the base polymer film comprises a bottom adhesive layer.

19. A scratch resistant film or laminate comprising
a base polymer film;
a coating on at least one of the surfaces of the base polymer film, and
one or more particles of biocide agents, zeolite, and diatomaceous earth, dispersed in the coating, wherein at least some of the individual particles extend beyond the surface of the coating when the coating is applied to the film.

20. The scratch resistant film or laminate of claim 19 wherein the thickness of the coating is less than the mean particle size.
